(19) United States
(12) Patent Application Publication
(10) Pub. No.: US 2026/0157348 A1
(43) Pub. Date: Jun. 11, 2026

(54) SYSTEM AND METHOD FOR HEATING AND MONITORING A PET HOUSE

(71) Applicant: ADR Products, LLC, Avon, OH (US)

(72) Inventors: David Scholtz, Avon, OH (US); Andrew Roseberry, Avon, OH (US)

(21) Appl. No.: 19/412,039

(22) Filed: Dec. 8, 2025

Related U.S. Application Data
(60) Provisional application No. 63/728,727, filed on Dec. 6, 2024.

(51) Int. Cl. A01K 29/00; A01K 1/03

(52) U.S. Cl. CPC A01K 29/005; A01K 1/0335

(57) ABSTRACT

A device and method for heating and monitoring a pet house are disclosed. The method includes heating a pet house with a device connected to the internet wirelessly, setting a temperature via a computer application, transmitting thermostat data and video image data to at least one computing device, receiving the data on a mobile device, and notifying the mobile device based on the data values.

### CROSS REFERENCE TO RELATED APPLICATION

This application claims priority to U.S. Provisional Patent Application No. 63/728,727 entitled “SYSTEM AND METHOD FOR HEATING AND MONITORING A PET HOUSE,” filed on Dec. 6, 2024, which is incorporated herein by reference in its entirety.

### FIELD OF THE INVENTION

The invention relates generally to a Wi-Fi-enabled system and a method that heats a pet house and that includes a camera.

### BACKGROUND OF THE INVENTION

Outdoor pet houses usually offer crude weather protection. Pets that spend time outdoors in cold environments with only a pet house for shelter are often exposed to intense cold conditions, if no heating source is provided. Furthermore, pet houses often do not offer security which exposes pets to possible dangers with limited human oversight. Pets in this situation may suffer from lack of heat and human supervision.

### SUMMARY

The following presents a simplified summary to provide a basic understanding of some aspects of the disclosed subject matter. This summary is intended to neither identify key or critical elements nor define any limitations of embodiments or claims. Furthermore, this summary may provide a simplified overview of some aspects that may be described in greater detail in other portions of this disclosure.

According to one aspect, a pet house heater and monitoring system comprising a housing, a heater element, a thermostat, a wireless transmitter, a computing device, a camera, and a computer-executable application, wherein the computer-executable application allows a user to monitor thermostat data and video images produced by the heater and the monitoring system.

According to another aspect, a computer-implemented method of heating and monitoring a pet house comprising heating a pet house with a device, wherein the device is connected to the internet wirelessly, setting the temperature via a computer application, transmitting thermostat data to at least one computing device, transmitting video image data to at least one computing device, receiving the thermostat data and the video image data on a mobile device, and notifying the mobile device based on values of the thermostat data and the video image data.

The following description and drawings disclose but a few of the various ways in which the principles of the subject disclosure may be employed. Some improvements and novel aspects may be expressly identified, while others may be apparent from the description and drawings.

### BRIEF DESCRIPTION OF THE DRAWINGS

The accompanying drawings illustrate systems, apparatuses, devices and methods, in which like reference characters refer to like parts throughout.

FIG. 1 illustrates a perspective view of a device, in accordance with various disclosed aspects;

FIG. 2 illustrates a top view of a device, in accordance with various disclosed aspects;

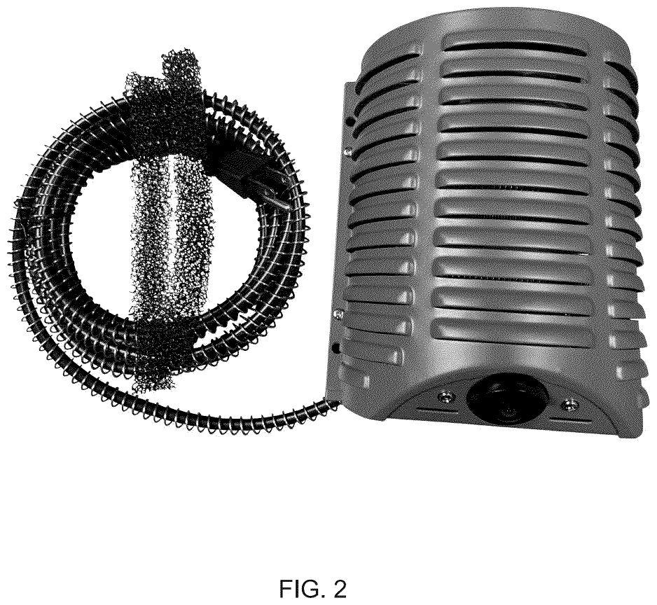

FIG. 3 illustrates a front view of a device, in accordance with various disclosed aspects;

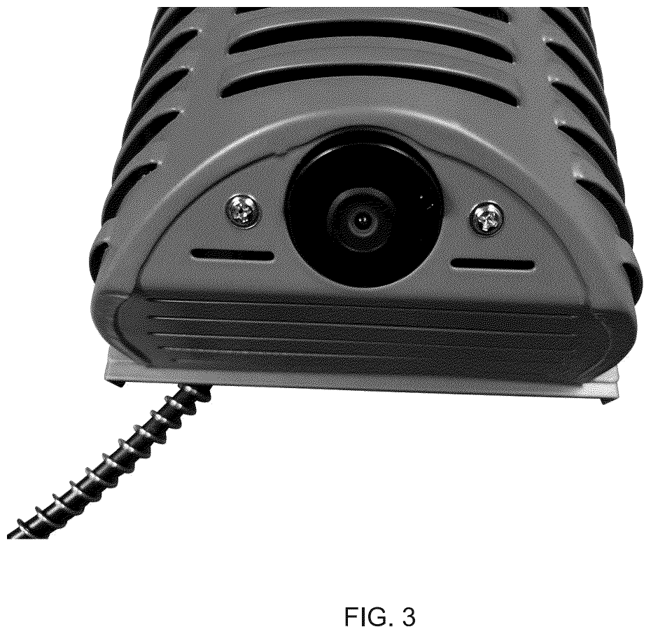

FIG. 4 illustrates a back view of a device, in accordance with various disclosed aspects;

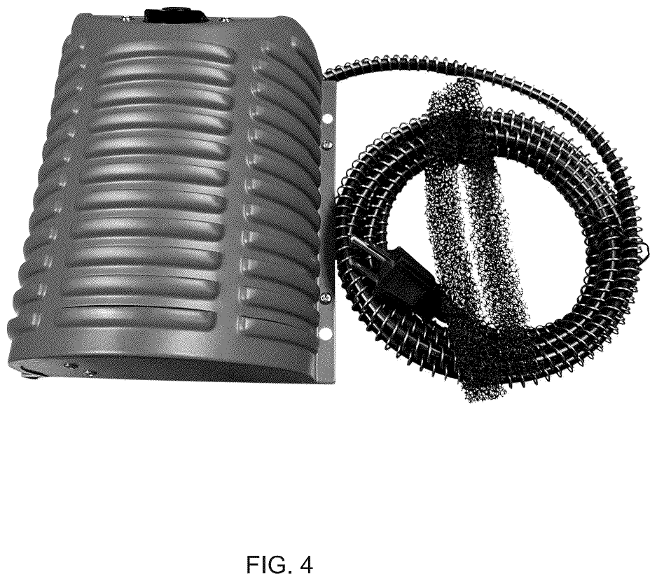

FIG. 5 illustrates a front view of a device, in accordance with various disclosed aspects.

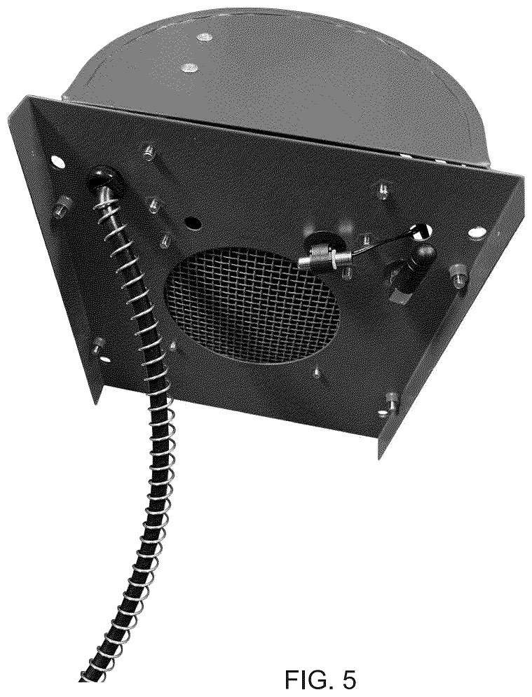

The disclosure may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION OF EMBODIMENTS

Reference will now be made in detail to exemplary embodiments of the present invention, examples of which are illustrated in the accompanying drawings. It is to be understood that other embodiments may be utilized, and structural and functional changes may be made without departing from the respective scope of the claims. Moreover, features of the various embodiments may be combined or altered without departing from the scope of the claims. As such, the following description is presented by way of illustration only and should not limit in any way the various alternatives and modifications that may be made to the illustrated embodiments and still be within the spirit and scope of the claims.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

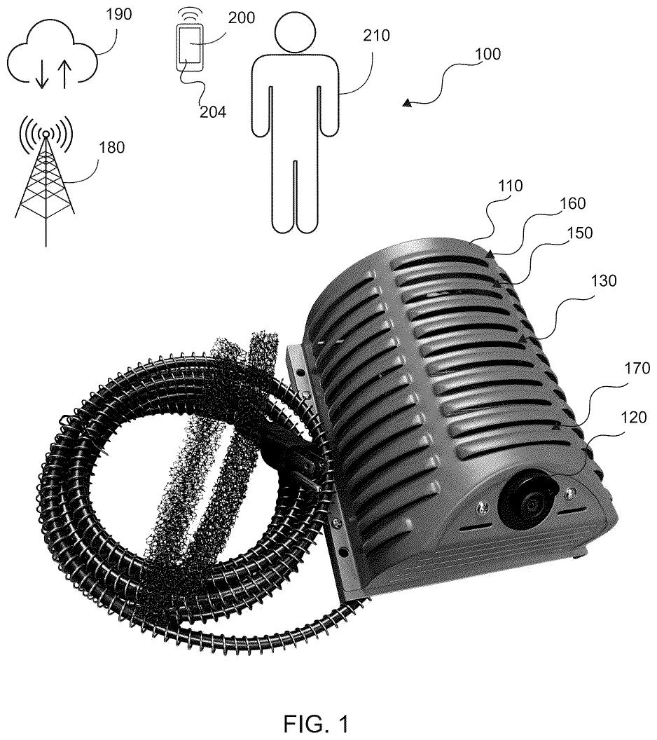

Shown in FIG. 1 is a system 100 for pet house heating and monitoring. The system 100 has a housing 110 that encloses a heater element 130, a thermostat 150, a wireless transmitter 160, at least one computing device 170, a camera 120; and a computer-executable application 204, wherein the computer-executable application 204 allows a user 210 to monitor thermostat data and video images produced by system 100 via a mobile device 200. Data from the system 100 may be sent via a wireless 180 infrastructure and stored by a cloud 190 service.

A user manual for the device, system, and method is incorporated herewith and is included as an appendix to the specification.

A pet house heater and monitoring system may include a housing, a heater element, a thermostat, a wireless transmitter, at least one computing device, a camera, and a computer-executable application. The computer-executable application allows a user to monitor thermostat data and video images produced by the pet house heater and monitoring system via a mobile device. In certain embodiments, the wireless transmitter comprises a Bluetooth transceiver and a Wi-Fi transceiver, and the computer-executable application is configured to establish a temporary Bluetooth connection with the system, transfer Wi-Fi credentials to the system, and connect the system to a local wireless network. The system may further comprise a visual indicator proximate to the camera that exhibits a slow-flashing state while the system is searching for Wi-Fi, exhibits a rapid-flashing state while pairing to Wi-Fi, and exhibits a steady-on state upon successful connection to Wi-Fi. The system may additionally comprise a reset button located adjacent to the camera, wherein pressing and holding the reset button for approximately five seconds initiates a reset sequence, and wherein the reset sequence returns the visual indicator to the slow-flashing state indicating readiness for provisioning.

The computer-executable application may be configured to present a control page that integrates a live video view from the camera, displays an actual room temperature value at a center of a circular dial, displays a set temperature on an outer rim of the circular dial, and is configured to control the heater element to activate when the actual room temperature is lower than the set temperature. In some implementations, the computer-executable application is configured to unbind the system from a user account via a device settings interface or by pressing and holding a device tile on a home page for approximately three seconds to prompt a confirmation dialog, and, upon confirmation, remove the system from the account. The computer-executable application is further configured to manage firmware upgrades by indicating availability of a new firmware version, presenting an equipment upgrade option, displaying upgrade progress with an instruction not to power off the system, and automatically restarting the system upon successful completion of the upgrade. In certain embodiments, the system is configured to transmit thermostat data and video image data via a wireless infrastructure for storage by a cloud service.

A computer-implemented method of heating and monitoring a pet house may include heating a pet house with a device, wherein a device is connected to the internet wirelessly, setting the temperature via a computer application, transmitting thermostat data to at least one computing device, transmitting video image data to at least one computing device, receiving the thermostat data and the video image data on a mobile device, and notifying the mobile device based on values of the thermostat data and the video image data. In some embodiments, the device is provisioned to the internet wirelessly by enabling Bluetooth and Wi-Fi on a mobile device, launching a companion application, establishing a temporary Bluetooth connection between the mobile device and the device, transferring, over the temporary Bluetooth connection, credentials for a local Wi-Fi network from the mobile device to the device, and connecting the device to the local Wi-Fi network using the transferred credentials.

The method may further comprise providing a visual indicator proximate to a camera of the device that exhibits a slow-flashing state while the device is searching for Wi-Fi, exhibits a rapid-flashing state while pairing to Wi-Fi, and exhibits a steady-on state upon successful connection to Wi-Fi. Upon failure to connect the device to the internet wirelessly, the method may comprise instructing a user to press and hold a reset button adjacent to the camera of the device for approximately five seconds to initiate a reset sequence, waiting for the reset sequence to complete, and re-entering a provisioning mode for renewed discovery and connection.

In certain embodiments, setting the temperature via the computer application comprises presenting a control page that integrates a live video view from an onboard camera, displaying an actual room temperature value at a center of a circular dial, displaying a set temperature on an outer rim of the dial, and receiving user input to adjust the set temperature by manipulating the dial. The method may further comprise unbinding the device from a user account via a device settings interface of the computer application or by pressing and holding a device tile on a home page for approximately three seconds to prompt a confirmation dialog and, upon confirmation, removing the device from the account. The method may also comprise initiating a firmware upgrade via the computer application by detecting availability of a new firmware version, navigating to a device settings page, selecting an equipment upgrade option, presenting upgrade progress with an instruction not to power off the device, and automatically restarting the device upon successful completion of the upgrade.

The computer-implemented method of heating and monitoring a pet house may comprises heating a pet house with a device, wherein the device is connected to the internet wirelessly, setting the temperature via a computer application, transmitting thermostat data to at least one computing device, transmitting video image data to at least one computing device, receiving the thermostat data and the video image data on a mobile device, and notifying the mobile device based on values of the thermostat data and the video image data.

The computer-implemented method of heating and monitoring a pet enclosure may comprise powering a heater device located at the pet enclosure, wherein the heater device comprises a heater element, a thermostat, an onboard camera, and a wireless transceiver, enabling Bluetooth and Wi-Fi radios on a mobile device and launching a companion application on the mobile device, establishing, via the companion application, a temporary Bluetooth connection between the mobile device and the heater device, transferring, from the mobile device to the heater device over the temporary Bluetooth connection, credentials for a local Wi-Fi network, connecting the heater device to the local Wi-Fi network using the transferred credentials, receiving, at the mobile device via the local Wi-Fi network and the internet, thermostat data generated by the thermostat and video image data generated by the onboard camera, presenting, by the companion application on the mobile device, a control interface that concurrently displays a room temperature value derived from the thermostat data and a set temperature, receiving, at the companion application, user input specifying the set temperature, operating the heater element to heat the pet enclosure when the room temperature value is lower than the set temperature, and generating and sending, by the companion application to the mobile device, a notification based on values of the thermostat data and the video image data.

The pet house heater and monitoring system can include a housing, a heater element mounted within the housing, a thermostat configured to sense a room temperature within a pet enclosure, an onboard camera coupled to the housing, a wireless transceiver subsystem comprising a Bluetooth transceiver and a Wi-Fi transceiver, a user-actuated reset button located adjacent to the onboard camera, a visual indicator proximate to the onboard camera and visible to a user, and an electronic controller operatively coupled to the heater element, the thermostat, the onboard camera, the wireless transceiver subsystem, the reset button, and the visual indicator. The electronic controller is configured to place the system into a provisioning mode in response to a press-and-hold of the reset button, to drive the visual indicator to the slow-flashing state while searching for a Wi-Fi network, to a rapid-flashing state while pairing to the Wi-Fi network, and to the steady-on state upon successful connection to the Wi-Fi network, and to energize the heater element when the sensed room temperature is below a set temperature. In such embodiments, the wireless transmitter comprises the Bluetooth transceiver and the Wi-Fi transceiver, and the computer-executable application is configured to establish the temporary Bluetooth connection with the system, transfer Wi-Fi credentials to the system, and connect the system to a local wireless network. The visual indicator proximate to the camera exhibits the slow-flashing, rapid-flashing, and steady-on states as described above, and the system further comprises the reset button located adjacent to the camera, wherein pressing and holding the reset button for approximately five seconds initiates the reset sequence and returns the visual indicator to the slow-flashing state indicating readiness for provisioning.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

The embodiments described herein relate to a SMART, Wi-Fi enabled pet-enclosure heater system with integrated video capability and a companion mobile application configured to provision, operate, monitor, and maintain a Hound Heater device. In certain implementations, the system comprises: a housing-mounted heater assembly with an onboard camera and status indicators; a wireless transceiver subsystem supporting Bluetooth and Wi-Fi for provisioning and operation; a mobile application configured to authenticate a user, bind to the heater via Bluetooth, transition the heater to a local Wi-Fi network, and provide a control interface including temperature setting, real-time room temperature display, device profile management, device unbinding, and firmware upgrade management.

In an exemplary embodiment, a user powers the heater device and ensures that a mobile phone has Bluetooth and Wi-Fi radios enabled. The user installs and opens a companion AKOMA application, selects “Sign Up,” registers by filling all fields, and enters a received six-digit verification code to complete account creation. Thereafter, the user logs in by entering an email and password and consenting to terms and device permissions, including permissions to access phone services and use of wireless data. On iOS and Android platforms, the application requests authorization to access wireless data, Bluetooth, location services (approximate and/or precise), nearby device discovery, and microphone resources as needed to discover and communicate with the heater during provisioning and operation.

Following authentication, the application displays a home view with an “Add Device” function. Upon selection, the application initiates device discovery and, when appropriate, instructs the user to press and hold a reset button located adjacent to the camera for approximately five seconds to place the heater into a provisioning mode if the device is not found. The application binds to the heater via Bluetooth through a “Bind to Bluetooth” workflow that establishes a low-energy connection between the mobile device and the heater for subsequent Wi-Fi credential transfer. During initial setup, the heater and mobile device are positioned within a few feet of each other and within direct line of sight of the Wi-Fi router to maximize signal strength and connection stability. The system confirms that, for first-time connection, the heater is located within approximately five feet of the Wi-Fi router to improve provisioning reliability.

In certain implementations, the application executes a multi-stage workflow to connect the heater to the local wireless network. A user selects a local WLAN, enters a corresponding password, and confirms to proceed. The application is permitted to find and connect to the heater on the local network. A green indicator light proximate to the camera provides the following visual states: slow flashing while the device is searching for Wi-Fi, rapid flashing while pairing to Wi-Fi, and steady illumination upon successful connection to Wi-Fi. The network association process may take up to approximately two minutes to complete. If an incorrect Wi-Fi network name or password is provided, or if the Wi-Fi signal is insufficient, the application provides a “Connection Failed” notification and instructs the user to press and hold the camera-adjacent reset button for approximately five seconds to reset the device, wait for the reset sequence to complete, and then repeat the add-device workflow. After initial configuration, the heater can be moved to any location that meets required upload and download speeds for stable operation.

Upon successful network connection, the application presents a control page for the heater. In some embodiments, this control page integrates a live video view sourced from the onboard camera, which may require approximately 30 seconds or longer to initialize. The control page displays an actual room temperature value at the center of a circular dial and a set temperature on the dial's outer rim. A user presses and holds the dial and moves it to a desired set temperature; the heater activates when the room temperature is lower than the set temperature. The control page provides a convenient mechanism to return to a home page where the user can view a profile and add additional devices; selecting a device from the home page navigates back to that device's control page.

In various embodiments, device management is facilitated through a help and settings interface accessible via a “?” icon in the upper-right corner of the control page. The device settings view provides functions including device nickname editing, access to directions for use and video content, and the ability to unbind the device from the mobile account. As an alternative unbinding method, a user may press and hold the device tile on the home page for approximately three seconds, prompting a confirmation dialog; upon confirming, the home page displays “No Devices,” indicating successful unbinding. To re-provision, the heater can be reset by pressing and holding the reset button for about five seconds, whereupon the green LED flashes rapidly for approximately 10 seconds, turns off for approximately 18 seconds, and then returns to a slow-flashing state for approximately 10 seconds, indicating completion of the reset sequence and readiness for provisioning.

The system includes user profile management functions. A “Profile” section allows a user to modify account details, including adding or changing a profile photo via a photo album selection, changing the account password by entering an old password and new password with confirmation, and resetting the password if desired. The profile view also exposes basic information, frequently asked questions, support contact information, and account lifecycle controls such as cancel account and log out.

In preferred implementations, firmware management is integrated into the application to simplify device maintenance and feature updates. When a new firmware version is available, a small red dot appears next to the “?” icon on the control page, and an exclamation indicator appears adjacent to “Device Settings.” Within “Device Settings,” an “Equipment upgrade” entry displays the current firmware version and, when a newer version exists, a latest available version along with an “Upgrade now” affordance. During the upgrade process, the application indicates progress (e.g., “Upgrading... The device is being upgraded. Please do not power off.”). Upon successful completion, the device restarts automatically and the application updates version information accordingly. Users are instructed not to power off the device while an upgrade is in progress.

The foregoing embodiments provide a cohesive provisioning, control, and maintenance workflow tailored to a Wi-Fi enabled pet house heater with integrated camera. By leveraging Bluetooth binding for initial credential transfer, in-app visual and textual guidance, multi-state LED indicators tied to network connection phases, and a consolidated control page with room temperature telemetry and set-point control, the system increases reliability and usability during initial onboarding and routine operation. The integration of profile controls, unbinding workflows accessible both from device settings and the home page, and firmware upgrade orchestration with explicit in-app prompts further contributes to a robust user experience throughout the device lifecycle.

In an aspect, a method of provisioning the heater includes the steps of: enabling Bluetooth and Wi-Fi on a mobile device; installing and launching the companion application; registering for an account and authenticating; initiating device discovery via an “Add Device” function; entering Bluetooth binding mode and establishing a temporary Bluetooth connection to the heater; selecting a local WLAN and entering a password; authorizing the application to discover devices on the local network; and confirming Wi-Fi association via the green LED state transitioning from slow flash to rapid flash to steady on. Upon failure, the method includes a reset step in which the user presses and holds a camera-adjacent reset button to re-enter provisioning mode before repeating discovery and binding. The method may further include relocating the heater post-provisioning to any environment meeting minimum network throughput requirements.

In another aspect, a method of operating the heater via the application includes the steps of: navigating to a control page; observing a displayed room temperature value; adjusting a set temperature by manipulating a dial's outer rim; and allowing the heater control logic to energize heating elements when the room temperature falls below the set temperature. The method also optionally includes viewing an onboard camera's video stream, returning to the home page, and selecting among multiple provisioned devices. The operating method is further complemented by user account management and device lifecycle functions, including device unbinding and firmware upgrades initiated from device settings.

In yet another aspect, a firmware upgrade method includes: identifying availability of a new firmware version via in-app indicators; navigating to device settings; selecting “Equipment upgrade”; comparing current and latest firmware versions; and initiating an upgrade by selecting “Upgrade now.” During upgrade execution, the application communicates progress and instructs the user not to power off the device. Upon completion, the device restarts automatically and the application reflects the updated version, thereby completing the upgrade process in a user-transparent manner.

Although specific terms such as “AKOMA,” “Hound Heater,” “Add Device,” “Bind to Bluetooth,” and “Equipment upgrade” are used herein to provide clarity, such labels are exemplary and non-limiting. Equivalent user interface elements, networking subsystems, indicator modalities, and control logic that accomplish the same functionality are intended to be within the scope of the described embodiments. The described features may be implemented individually or in any practicable combination to achieve reliable provisioning, intuitive operation, and maintainability of a network-connected pet enclosure heating system with integrated video capability.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A pet house heater and monitoring system, comprising:
a housing;
a heater element;
a thermostat;
a wireless transmitter;
at least one computing device;
a camera; and
a computer-executable application, wherein the computer-executable application allows a user to monitor thermostat data and video images produced by the pet house heater and monitoring system via a mobile device.

2. The system of claim 1, wherein the wireless transmitter comprises:
a Bluetooth transceiver; and
a Wi-Fi transceiver;
and wherein the computer-executable application is configured to:
establish a temporary Bluetooth connection with the system;
transfer Wi-Fi credentials to the system; and
connect the system to a local wireless network.

3. The system of claim 1, further comprising a visual indicator proximate to the camera that:
exhibits a slow-flashing state while the system is searching for Wi-Fi;
exhibits a rapid-flashing state while pairing to Wi-Fi; and
exhibits a steady-on state upon successful connection to Wi-Fi.

4. The system of claim 1, further comprising:
a reset button located adjacent to the camera;
wherein pressing and holding the reset button for approximately five seconds initiates a reset sequence; and
wherein the reset sequence returns the visual indicator to a slow-flashing state indicating readiness for provisioning.

5. The system of claim 1, wherein the computer-executable application is configured to present a control page that:
integrates a live video view from the camera;
displays an actual room temperature value at a center of a circular dial;
displays a set temperature on an outer rim of the circular dial; and
is configured to control the heater element to activate when the actual room temperature is lower than the set temperature.

6. The system of claim 1, wherein the computer-executable application is configured to unbind the system from a user account via:
a device settings interface; or
pressing and holding a device tile on a home page for approximately three seconds to prompt a confirmation dialog; and
upon confirmation, remove the system from the account.

7. The system of claim 1, wherein the computer-executable application is configured to manage firmware upgrades by:
indicating availability of a new firmware version;
presenting an equipment upgrade option;
displaying upgrade progress with an instruction not to power off the system; and
automatically restarting the system upon successful completion of the upgrade.

8. The system of claim 1, wherein the system is configured to transmit thermostat data and video image data via a wireless infrastructure for storage by a cloud service.

9. A computer-implemented method of heating and monitoring a pet house, the method comprising:
heating a pet house with a device, wherein the device is connected to the internet wirelessly;
setting the temperature via a computer application;
transmitting thermostat data to at least one computing device;
transmitting video image data to at least one computing device;
receiving the thermostat data and the video image data on a mobile device, and
notifying the mobile device based on values of the thermostat data and the video image data.

10. The method of claim 9, wherein the device is provisioned to the internet wirelessly by:
enabling Bluetooth and Wi-Fi on a mobile device;
launching a companion application;
establishing a temporary Bluetooth connection between the mobile device and the device;
transferring, over the temporary Bluetooth connection, credentials for a local Wi-Fi network from the mobile device to the device; and
connecting the device to a local Wi-Fi network using the transferred credentials.

11. The method of claim 9, further comprising providing a visual indicator proximate to a camera of the device that:
exhibits a slow-flashing state while the device is searching for Wi-Fi;
exhibits a rapid-flashing state while pairing to Wi-Fi; and
exhibits a steady-on state upon successful connection to Wi-Fi.

12. The method of claim 9, further comprising, upon failure to connect the device to the internet wirelessly:
instructing a user to press and hold a reset button adjacent to a camera of the device for approximately five seconds to initiate a reset sequence;
waiting for the reset sequence to complete; and
re-entering a provisioning mode for renewed discovery and connection.

13. The method of claim 9, wherein setting the temperature via the computer application comprises:
presenting a control page that integrates a live video view from an onboard camera;
displaying an actual room temperature value at a center of a circular dial;
displaying a set temperature on an outer rim of the dial; and
receiving user input to adjust the set temperature by manipulating the dial.

14. The method of claim 9, further comprising unbinding the device from a user account via:
a device settings interface of the computer application; or
pressing and holding a device tile on a home page for approximately three seconds to prompt a confirmation dialog; and
upon confirmation, removing the device from the account.

15. The method of claim 9, further comprising initiating a firmware upgrade via the computer application by:
detecting availability of a new firmware version;
navigating to a device settings page;
selecting an equipment upgrade option;
presenting upgrade progress with an instruction not to power off the device; and
automatically restarting the device upon successful completion of the upgrade.

16. A computer-implemented method of heating and monitoring a pet enclosure, the method comprising:
powering a heater device located at the pet enclosure, the heater device comprising a heater element, a thermostat, an onboard camera, and a wireless transceiver;
enabling Bluetooth and Wi-Fi radios on a mobile device and launching a companion application on the mobile device;
establishing, via the companion application, a temporary Bluetooth connection between the mobile device and the heater device;
transferring, from the mobile device to the heater device over the temporary Bluetooth connection, credentials for a local Wi-Fi network;
connecting the heater device to the local Wi-Fi network using the transferred credentials;
receiving, at the mobile device via the local Wi-Fi network and the internet, thermostat data generated by the thermostat and video image data generated by the onboard camera;
presenting, by the companion application on the mobile device, a control interface that concurrently displays a room temperature value derived from the thermostat data and a set temperature;
receiving, at the companion application, user input specifying the set temperature;
operating the heater element to heat the pet enclosure when the room temperature value is lower than the set temperature; and
generating and sending, by the companion application to the mobile device, a notification based on values of the thermostat data and the video image data.

17. A pet house heater and monitoring system, comprising:
a housing;
a heater element mounted within the housing;
a thermostat configured to sense a room temperature within a pet enclosure;
an onboard camera coupled to the housing;
a wireless transceiver subsystem;
a user-actuated reset button located adjacent to the onboard camera;
a visual indicator proximate to the onboard camera and visible to a user; and
an electronic controller operatively coupled to the heater element, the thermostat, the onboard camera, the wireless transceiver subsystem, the reset button, and the visual indicator, the controller being configured to place the system into a provisioning mode in response to a press-and-hold of the reset button, to drive the visual indicator to a slow-flashing state while searching for a Wi-Fi network, to a rapid-flashing state while pairing to the Wi-Fi network, and to a steady-on state upon successful connection to the Wi-Fi network, and to energize the heater element when the sensed room temperature is below a set temperature.

18. The system of claim 17, wherein the wireless transmitter comprises:
a Bluetooth transceiver; and
a Wi-Fi transceiver;
and wherein the computer-executable application is configured to:
establish a temporary Bluetooth connection with the system;
transfer Wi-Fi credentials to the system; and
connect the system to a local wireless network.

19. The system of claim 17, further comprising a visual indicator proximate to the camera that:
exhibits a slow-flashing state while the system is searching for Wi-Fi;
exhibits a rapid-flashing state while pairing to Wi-Fi; and
exhibits a steady-on state upon successful connection to Wi-Fi.

20. The system of claim 17, further comprising:
a reset button located adjacent to the camera;
wherein pressing and holding the reset button for approximately five seconds initiates a reset sequence; and
wherein the reset sequence returns the visual indicator to a slow-flashing state indicating readiness for provisioning.
